(19) United States
(12) Patent Application Publication
(10) Pub. No.: US 2011/0132843 A1
(43) Pub. Date: Jun. 9, 2011

(54) Composite as Adsorbent and Catalyst, Manufacturing Method Thereof, and Method of Treating Wastewater Using Same

(75) Inventor: Huan-Jung Fan, Taichung City (TW)

(73) Assignee: HUNGKUANG UNIVERSITY, Taichung County (TW)

(21) Appl. No.: 12/827,453

(22) Filed: Jun. 30, 2010

(30) Foreign Application Priority Data
Dec. 9, 2009 (TW) 098142153

(51) Int. Cl. C02F 1/42; C02F 1/72; B01J 21/18; C02F 101/20; C02F 101/30

(52) U.S. Cl. 210/668; 210/660; 210/688; 502/182; 502/185; 977/811; 977/903

(57) ABSTRACT

A composition as adsorbent and catalyst is manufactured by adding activated carbon into a aqueous solution comprising a plurality of metal salts, adjusting the solution to a predetermined pH value according to the types of the plurality of metal salts, drying the solution while slowly stirring at the same time, and calcining a product from the dried aqueous solution so as to obtain the composite as adsorbent and catalyst. The said composite can be used in a wastewater treatment method. The wastewater treating method comprises the steps of adding the said composite to wastewater comprising a contaminant, such that the contaminant is adsorbed onto the composite; and adding an oxidant to the wastewater. The oxidant is catalyzed by the composite to generate free radicals, which oxidizes the contaminant adsorbed onto the composite to thereby remove the contaminant from the wastewater.

### FIELD OF THE INVENTION

The present invention relates to a composite, a manufacturing method thereof, and applications thereof; and more particularly, to a composite as adsorbent and catalyst, a manufacturing method thereof, and a wastewater treatment method using the composite.

### BACKGROUND OF THE INVENTION

Waste management has become a very important issue in the modern society. With the rapid development in the industrial and commercial fields, constantly upgraded living quality and continuously developed new products, the quantity of waste also increases quickly. In Taiwan, the waste is eventually disposed in the landfill. One of the main environmental problems of landfill is the landfill leachate. Without proper handling, the leachate might cause serious environmental problems. For example, landfill leachate might pollute the soil and groundwater. The landfill leachate often contains relatively high concentrations of non-biodegradable organic substances and heavy metals. For example, and humic acid (HA) is one of the main organic substances in the landfill leachate. In addition, the HA might complex with heavy metals and enhance the mobility of the heavy metals in groundwater. As a result, HA speeds up the pollution processes. Therefore, it is very important to remove HA and heavy metals from landfill leachate.

In general, there are many different wastewater treatment processes available for use, such as chemical coagulation processes, biological treatment processes, microfiltration membrane processes, and advanced oxidation processes. The chemical coagulation processes have the advantages of less affected by temperature changes, short treatment time, less affected by changes in water quality, and showing good performance of the leachate treatment. However, the chemical coagulation processes also have the disadvantage that the treatment efficiency thereof is frequently affected by salts and pH values in the leachate. Further, the chemical coagulation processes fail to reduce the chemical oxygen demand (COD) in the wastewater to the code-required level, that is, below 200 mg/L, and would produce a large quantity of sludge so as to cause the problem of subsequent sludge treatment. The biological treatment processes are more suitable for treating leachate generated from young landfill ages (e.g. 1-3 years). However, since most of the sanitary landfills in Taiwan have been used for a long time, the biological treatment processes have limited treatment efficiency as regards to landfill leachate. The microfiltration membrane processes have the advantages of high treatment efficiency and short treatment time, but it requires high handling cost and has the problem of membrane fouling.

### SUMMARY OF THE INVENTION

A primary object of the present invention is to provide a composite as adsorbent and catalyst, a manufacturing method thereof, and a wastewater treatment method using same, so as to remove the highly concentrated and uneasily decomposable organic substances and heavy metals from wastewater.

To achieve the above and other objects, the composite as adsorbent and catalyst according to the present invention comprises activated carbon and metal oxides. The metal oxides are coated on a surface of the activated carbon or filled in pores of the activated carbon. Further, the metal oxides include oxides comprising a plurality of metals.

The manufacturing method of the composite as adsorbent and catalyst according to the present invention comprises the following steps. Activated carbon is added to an aqueous solution comprising a plurality of metal salts, and the aqueous solution is adjusted to predetermined pH values according to types of the plurality of metal salts. The aqueous solution comprising the plurality of metal salts and the activated carbon is dried and slowly stirred simultaneously. A product (the composite) obtained after drying the solution is calcined, such that a surface or pores of the activated carbon is coated with metal oxides.

In the wastewater treatment method according to the present invention, the following steps are comprised. The composite as adsorbent/catalyst obtained using the above-described manufacturing method is added into wastewater comprising contaminants, such that the contaminants are adsorbed onto the composite. When the contaminants are heavy metals, the heavy metals are directly adsorbed onto the composite. Additionally, when the contaminants are organic substances, an oxidant can be added to the wastewater, such that the oxidant is catalyzed by the composite to generate free radicals, which in turn oxidizes the organic substances adsorbed onto the composite. Therefore, the contaminants either heavy metals or organic substances are removed from the wastewater.

Accordingly, the composite as adsorbent and catalyst, the manufacturing method thereof, and the wastewater treatment method using the composite according to the present invention provide one or more of the following advantages:

(1) The composite as adsorbent and catalyst according to the present invention has the function of catalyzing an oxidant to generate free radicals. The free radicals will be used to removal or oxidized the contaminants.

(2) The composite as adsorbent and catalyst according to the present invention is repeatedly usable to thereby save the cost of replacing the composite. Further, the composite can be designed used in a fixed bed reactor, such that contaminants in the wastewater are adsorbed onto the composite when the wastewater flows through the fixed bed, and the oxidant can be added to the fixed bed to further remove the adsorbed contaminants.

(3) In the wastewater treatment method according to the present invention, the composite as adsorbent and catalyst is able to remove organic substances and heavy metals. The composite plus the effect of the added oxidant enables good contaminants removal efficiency.

(4) The wastewater treatment method according to the present invention can be applied in landfill leachate treatment, dye contaminated wastewater treatment or electroplating wastewater treatment.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart of a manufacturing method of a composite as adsorbent and catalyst according to the present invention;

FIG. 2 is a flowchart of a wastewater treatment method according to the present invention;

FIG. 3 shows an SEM image of the surface of activated carbon;

FIG. 4 shows SEM images of MnCe-GAC-Cl obtained according to the manufacturing method of the present invention;

FIG. 5 shows SEM images of MnCe-GAC-NO₃ obtained according to the manufacturing method of the present invention;

FIG. 6 shows SEM images of FeCe-GAC-Cl obtained according to the manufacturing method of the present invention;

FIG. 7 shows SEM images of FeCe-GAC-NO₃ obtained according to the manufacturing method of the present invention;

FIG. 8 is a bar chart showing the humic acid removal efficiencies of MnCe-GAC-Cl, FeCe-GAC-Cl, and FeMn-GAC-Cl;

FIG. 9 is a bar chart showing the humic acid removal efficiency of MnCe-GAC-NO₃, FeCe-GAC-NO₃, and FeMn-GAC-NO₃;

FIG. 10 illustrates bar charts that separately show the humic acid removal efficiency of (a) ozone, (b) activated carbon/ozone, and (c) FeMn-A-200-NO₃/O₃ and (d) FeMn-A-300-NO₃/O₃ of the present invention at different pH values;

FIG. 11 is a bar chart showing the humic acid removal efficiency of different types of BM-GAC-Cl/H₂O₂ of the present invention at pH 3;

FIG. 12 is a bar chart showing the humic acid removal efficiency of different types of BM-GAC-NO₃/H₂O₂ of the present invention at pH 3;

FIG. 13 is a point chart showing the adsorption of copper ions onto FeCe-GAC-NO₃ of the present invention;

FIG. 14 is a bar chart showing the influence of copper ions on the humic acid removal efficiency of FeMn-GAC-NO₃/O₃ of the present invention; and

FIG. 15 is a bar chart showing the humic acid removal efficiency of MnCe-GAC/O₃ and FeMn-GAC/O₃ of the present invention in repeated use thereof.

### DETAILED DESCRIPTION OF THE PREFERRED EMBODIMENTS

The present invention will now be described with some preferred embodiments thereof with reference to the accompanying drawings. It is understood the experimental data shown in the embodiments are provided only for easy interpretation of the technical means of the present invention and should in no means be considered as restriction to the present invention.

### Embodiment 1

### Composite as Adsorbent and Catalyst

The present invention provides a composite as adsorbent and catalyst, which comprises activated carbon and metal oxides. The metal oxides are coated on external and internal surface (pores) of the activated carbon. The metal oxides are oxides comprising a plurality of metals, and the oxides coated on the surface or the pores of the activated carbon form a nanostructure coating film. The plurality of metals may comprise transition metals or inner transition metals. The transition metals may be iron or manganese, and the inner transition metals may be cerium.

### Embodiment 2

### Manufacturing Method of the Composite as Adsorbent and Catalyst

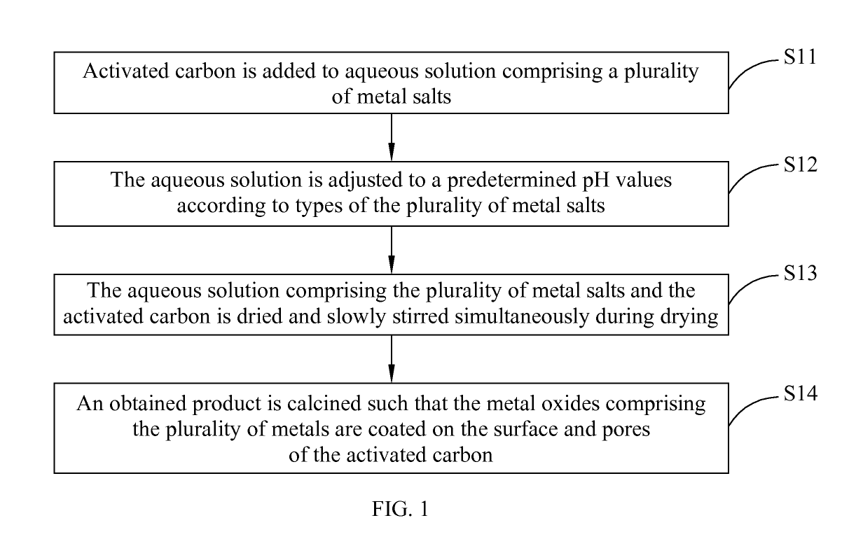

Please refer to FIG. 1 that is a flowchart of a manufacturing method of the composite as adsorbent and catalyst according to the present invention. As shown, the steps include as follows. In step S11, the activated carbon is added to aqueous solution comprising a plurality of metal salts. In step S12, the aqueous solution is adjusted to a predetermined pH values according to types of the plurality of metal salts. In step S13, the aqueous solution comprising the plurality of metal salts and the activated carbon is dried and slowly stirred simultaneously during drying, such that metal particles of the plurality of metal salts are coated in pores of the activated carbon. In step S14, after the solution is dried, an obtained product is calcined such that the metal oxides comprising the plurality of metals are coated on the surface and pores of the activated carbon. The metal oxides coating the surface of the activated carbon form a nanostructure coating film. The calcining step is preferably performed in a nitrogen environment or an oxygen-free environment, and at a calcining temperature ranged between 50 and 600° C., and more preferably between 100 and 350° C.

In the above-described manufacturing method, the type of the plurality of metal salts may comprise chlorides, nitrates, or sulfates; and the plurality of metals are the same as those described in the embodiment 1 and are therefore not repeated herein. Further, when the metal oxides coated on the surface of the activated carbon comprises ferric chloride (FeCl₃) and manganese chloride (MnCl₂), ferric chloride (FeCl₃) and cerium chloride (CeCl₃), or cerium chloride (CeCl₃) and manganese chloride (MnCl₂), the predetermined pH values can be adjusted to range between 9 and 12. When the metal oxides comprises ferric nitrate and cerium nitrate, or ferric nitrate and manganese nitrate, the predetermined pH values can be adjusted to be smaller than 5, so as to obtain more significant adsorbing and catalyzing effect.

### Embodiment 3

### Method of Treating Wastewater

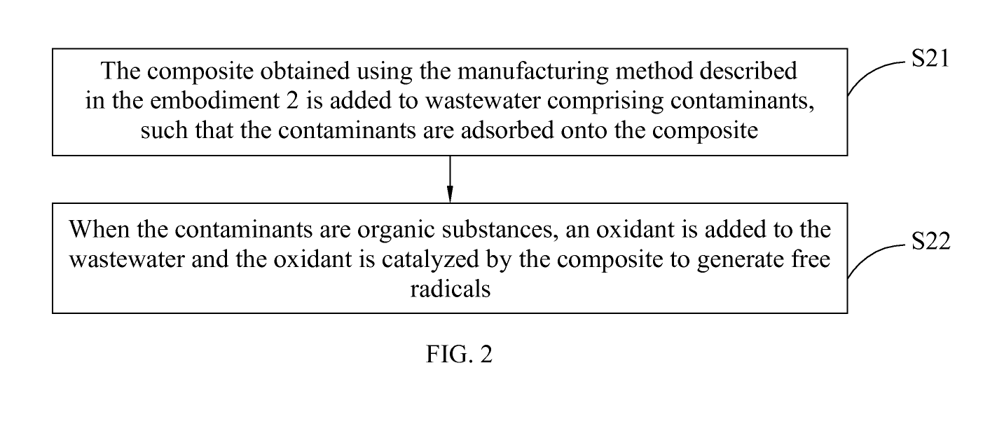

Please refer to FIG. 2 that is a flowchart of wastewater treatment method according to the present invention. As shown, the steps comprise as follows. In step S21, the composite obtained using the manufacturing method described in the embodiment 2 is added to wastewater comprising contaminants, such that the contaminants are adsorbed onto the composite. When the contaminants are heavy metals, the heavy metals are directly adsorbed onto the composite. In step S22, when the contaminants are organic substances, an oxidant is added to the wastewater. Thus, the oxidant is catalyzed by the composite to generate free radicals, and the organic substances adsorbed onto the composite are oxidized by the generated free radicals, and accordingly removed from the waste water.

Alternatively, the wastewater comprising the composite, the contaminants or the oxidants may be further irradiated with ultraviolet (UV) irradiation for the composite or the oxidants to generate free radicals, so that the free radicals oxidizes the contaminants adsorbed onto the composite. The contaminants can be organic substance such as humic substance and dyes. When the oxidant is ozone, pH values of the wastewater can be adjusted to be 8-14; and when the oxidant used is hydrogen peroxide, the pH values of the wastewater can be adjusted to be 1-5, in order to obtain better contaminant removal efficiency. In additional, heavy metals contained in the wastewater can be removed by adsorption onto the composite as well. The heavy metals may be copper, nickel, lead, cadmium or arsenic ions.

### Embodiment 4

### Preferred Embodiments of the Present Invention

Preparation of Bimetal Oxide-Granular Activated Carbon (BM-GAC):

One example of the composite as adsorbent and catalyst according to the present invention is BM-GAC, which may comprise manganese/cerium-granular activated carbon (MnCe-GAC), iron/cerium-granular activated carbon (FeCe-GAC), or iron/manganese-granular activated carbon (FeMn-GAC). Herein, as an example, the composite MnCe-GAC according to the present invention is prepared. First, MnCl₂.2H₂O and CeCl₃.7H₂O with a mol ratio of Mn/Ce being 6:4 are added to deionized water and fully mixed with the deionized water to prepare a solution. Then, the activated carbon is added to the prepared solution and the solution is left overnight. Sodium hydroxide (NaOH) is used to adjust the pH value of the solution according to actual requirement and then is kept the solution still for 4 hours before drying the solution. The dried solution is positioned in a covered crucible to minimize contact of oxygen. The dried solution positioned in the crucible is calcined separately at 200° C. and 300° C. for 3 hours, is washed with deionized water, and then is further dried for use later. Other types of BM-GAC according to the present invention may be prepared in similar procedures, and may be therefore not discussed in details herein.

Preparation of BM-GAC at Different Conditions:

Items to be discussed in this section comprise the types of the plurality of metal salts, pH values, and calcining temperatures to be used in preparing the composite. The types of the plurality of metal salts may comprise metal chloride and metal nitrate. The metal chloride may be manganese chloride (MnCl₂), cerium chloride (CeCl₃), or ferric chloride (FeCl₃); the metal nitrate can be manganese nitrate (Mn(NO₃)₂), cerium nitrate (Ce(NO₃)₃), or ferric nitrate (Fe(NO₃)₃). In the case the prepared composite has an unadjusted pH value generally ranged between 1 and 3, the code for the composite is marked by letter “U”. On the other hand, in the case the prepared composite has an adjusted pH value of 10, the code for the composite is marked by letter “A”. The calcining temperatures comprise 200° C. and 300° C. Table 1 below shows detailed conditions for preparing different types of BM-GAC.

TABLE 1
Preparation Conditions for Different Types of BM-GAC

| | | | |
|---|---|---|---|
| | | | Calcite Temperature |
| Code | Metal Salts | pH Value | (° C.) |

MnCe-GAC

| | | | |
|---|---|---|---|
| MnCe-U-200-Cl | MnCl₂ | <2.5 | 200 |
| MnCe-A-200-Cl | CeCl₃ | 10 | 200 |
| MnCe-U-300-Cl | | <2.5 | 300 |
| MnCe-A-300-Cl | | 10 | 300 |
| MnCe-U-200-NO₃ | Mn (NO₃)₂ | <2.0 | 200 |
| MnCe-A-200-NO₃ | Ce (NO₃)₃ | 10 | 200 |
| MnCe-U-300-NO₃ | | <2.0 | 300 |
| MnCe-A-300-NO₃ | | 10 | 300 |

FeCe-GAC

| | | | |
|---|---|---|---|
| FeCe-U-200-Cl | FeCl₃ | <2.0 | 200 |
| FeCe-A-200-Cl | CeCl₃ | 10 | 200 |
| FeCe-U-300-Cl | | <2.0 | 300 |
| FeCe-A-300-Cl | | 10 | 300 |
| FeCe-U-200-NO₃ | Fe (NO₃)₃ | <1.5 | 200 |
| FeCe-A-200-NO₃ | Ce (NO₃)₃ | 10 | 200 |
| FeCe-U-200-NO₃ | | <1.5 | 300 |
| FeCe-A-200-NO₃ | | 10 | 300 |

FeMn-GAC

| | | | |
|---|---|---|---|
| FeMn-U-200-Cl | FeCl₃ | <2.0 | 200 |
| FeMn-A-200-Cl | MnCl₂ | 10 | 200 |
| FeMn-U-300-Cl | | <2.0 | 300 |
| FeMn-A-300-Cl | | 10 | 300 |
| FeMn-U-200-NO₃ | Fe (NO₃)₃ | <1.5 | 200 |
| FeMn-A-200-NO₃ | Mn (NO₃)₂ | 10 | 200 |
| FeMn-U-300-NO₃ | | <1.5 | 300 |
| FeMn-A-300-NO₃ | | 10 | 300 |

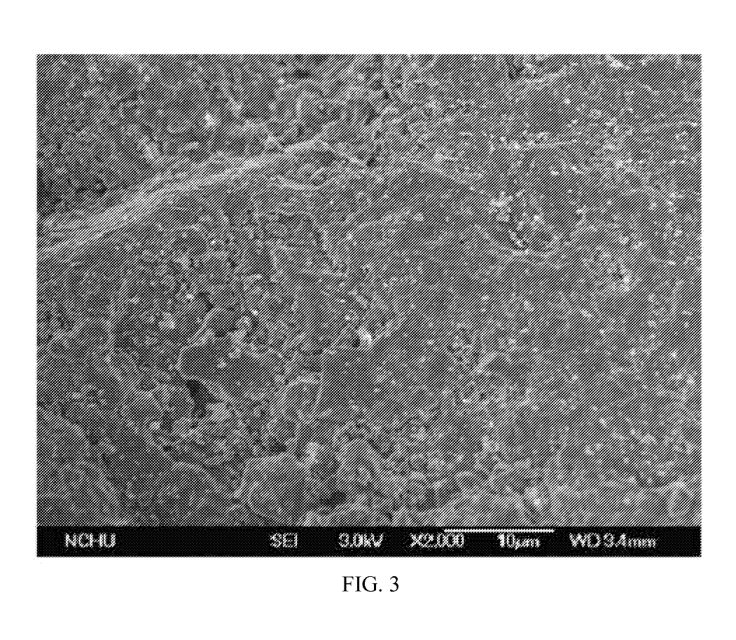

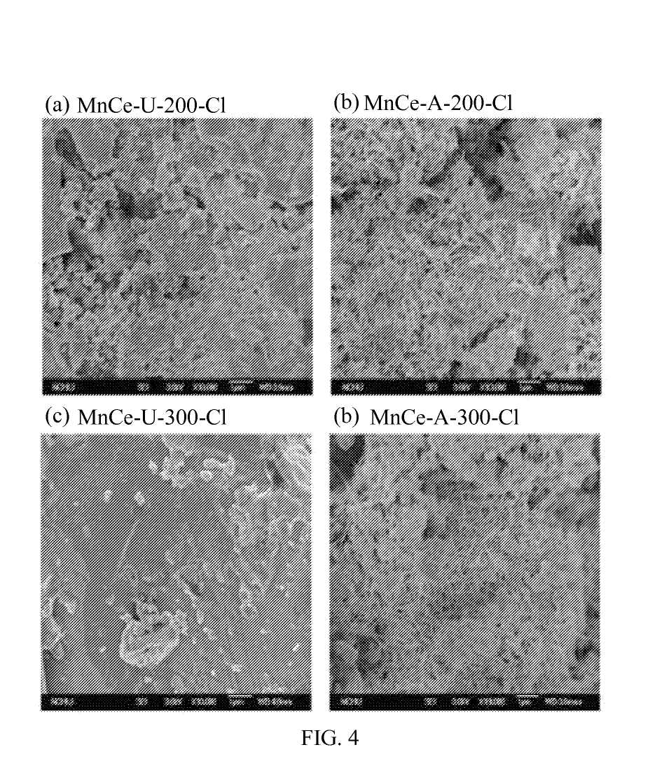

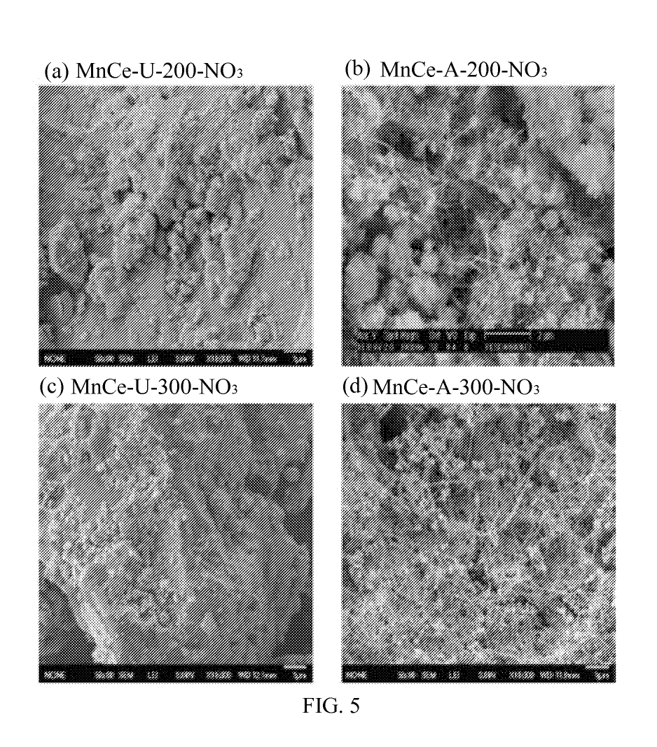

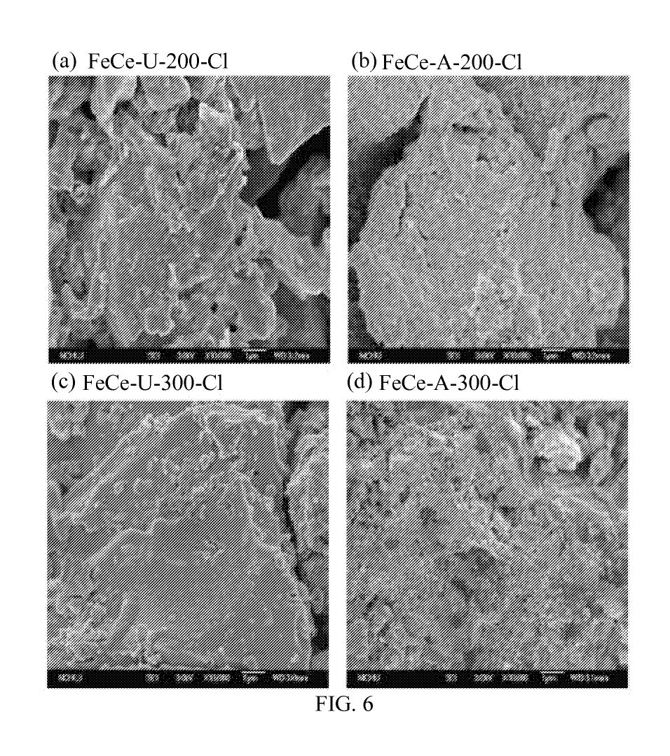

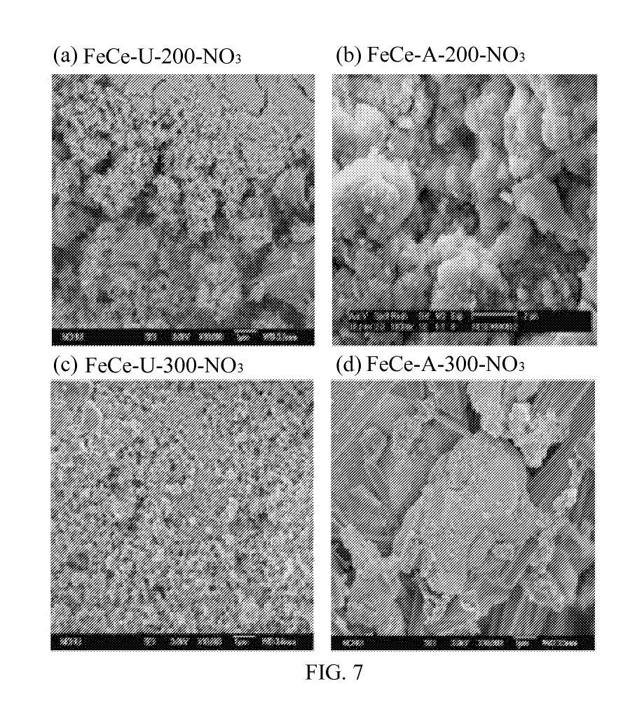

A scanning electron microscope (SEM) is used to analyze the surface of different types of BM-GAC prepared at different conditions. FIG. 3 shows an SEM image of a surface of a granular activated carbon (GAC) without any metal coating. The GAC surface without any metal coating is relatively smooth compared to BM-GACs prepared according to the present invention. FIGS. 4(a), (b), (c) and (d) show the SEM images of MnCe-U-200-Cl, MnCe-A-200-Cl, MnCe-U-300-Cl, and MnCe-A-300-Cl, respectively. FIGS. 5(a), (b), (c) and (d) show the SEM images of MnCe-U-200-NO₃, MnCe-A-200-NO₃, MnCe-U-300-NO₃, and MnCe-A-300-NO₃, respectively. As can be seen from FIGS. 4 (b), (d) and 5(b), (d) have silk-like metal nanostructure on their respective surface. Furthermore, FIGS. 6(a), (b), (c) and (d) show the SEM images of FeCe-U-200-Cl, FeCe-A-200-Cl, FeCe-U-300-Cl, and FeCe-A-300-Cl, respectively. As can be seen from FIG. 6, compared to the surface structure of the GAC, all the different types of BM-GAC shown in FIG. 6 have relatively coarse surface due to the oxidized metals attached thereto. And, FIGS. 7(a), (b), (c) and (d) show the SEM images of FeCe-U-200-NO₃, FeCe-A-200-NO₃, FeCe-U-300-NO₃, and FeCe-A-300-NO₃, respectively. As shown in FIG. 7, all BM-GAC apparently have aggregated substances attached on their respective surface.

Adsorption Capacity of BM-GAC—Coating Amount Test and Metal Oxide Dissolution Test:

Each of the prepared BM-GAC is subjected to a microwave digestion method, so as to extract the metals in the BM-GAC. After the microwave digestion is completed, the extraction fluid in the digestion vessel is filtered to remove solid matters. An inductively coupled plasma atomic emission spectroscopy (ICP/AES) is used to measure the metal concentrations in the digested solution. The measured metal concentrations are divided by the weight (g) of the BM-GAC to derive the metal content per gram of the activated carbon (mg/g GAC). And, a specific surface area analyzer (BET) is used to measure the specific surface area of the BM-GAC.

The following are results from the coating amount tests conducted on the different types of BM-GAC prepared according to the present invention: (1) MnCe-GAC: the coating amounts of Mn and of Ce are ranged from 52.93 to 77.27 mg/g and from 9.08 to 12.54 mg/g, respectively; wherein MnCe-GAC prepared at pH<2.5 shows better Mn coating amount. In general, MnCe-GAC prepared at pH<2.0 with nitrate salts shows better total coating amount (Mn+Ce) of 85-90 mg/L. (2) FeCe-GAC: the coating amounts of Fe and of Ce are ranged from 46.67 to 84.75 mg/g and from 4.71 to 79.98 mg/g, respectively; wherein FeCe-GAC prepared at pH<1.5 and with nitrate salts shows better Fe coating amount of about 84 mg/g, and FeCe-GAC prepared at pH 10 and with chloride salts shows better Ce coating amount of 70-80 mg/g. In general, FeCe-GAC prepared at pH 10 and with chloride salts shows better total coating amount (Fe+Ce) of 125-150 mg/L. (3) FeMn-GAC: the coating amounts of Fe and of Mn are ranged from 29.29 to 99.70 mg/g and from 2.84 to 69.91 mg/g, respectively; wherein FeMn-GAC prepared at pH 10 and with nitrate salts shows better Fe and Mn coating amounts about 86-99 mg/g and 62-70 mg/g, respectively. In conclusion, FeMn-GAC prepared at pH<1.5 with nitrate salts shows better total coating amount (Fe+Mn) of 145-170 mg/L.

The dissolution rate of the bimetal oxides coated on the BM-GAC in deionized water is analyzed. In general, a very low metals dissolution rate is found. A low metal dissolution rate indicates a higher the coating strength between bimetals oxides and GAC.

The following are results from the metal oxide dissolution tests conducted on the BM-GAC prepared with different metal salts according to the present invention. (1) BM-GAC prepared at pH 10 and with metal chlorides shows a lower dissolution rate; wherein FeCe-A-200-Cl and FeCe-A-300-Cl show relatively low dissolution rates of 0.47% and 0.26%, respectively, and accordingly have higher coating strength. Further, the calcining temperature has no significant influence on the dissolution rates of FeCe-A-200-Cl and of FeCe-A-300-Cl. (2) BM-GAC prepared at pH<2.5 and with metal nitrates shows a lower dissolution rate, with the exception of MnCe-GAC showing lower dissolution rate when being prepared at pH<10. In general, FeCe-U-200-NO₃ and FeCe-U-300-NO₃ have the lowest dissolution rates of 0.16% and 0.25%, respectively, and accordingly have better coating strength. Again, the calcite temperature has no significant influence on the dissolution rates of FeCe-U-200-NO₃ and FeCe-U-300-NO₃. In conclusion, FeCe-GAC shows better coating strength than other bimetal GAC (BM-GAC). Detailed data about the bimetal oxide dissolution rates of different types of BM-GAC are shown in the following Table 2.

TABLE 2
Bimetal Oxides Dissolution Rates of Different Types of BM-GAC
MnCe-GAC

| | | Dissolved | |
|---|---|---|---|
| | Coating Amount | Amount | Dissolution |
| | (mg/g) | (mg/g) | Rate (%) |
| Code | Mn + Ce | Mn + Ce | Mn + Ce |
| MnCe-U-200-Cl | 81.13 | 3.15 | 3.89 |
| MnCe-A-200-Cl | 73.87 | 1.53 | 2.08 |
| MnCe-U-300-Cl | 83.80 | 2.89 | 3.45 |
| MnCe-A-300-Cl | 66.96 | 1.92 | 2.87 |
| MnCe-U-200-NO₃ | 89.81 | 6.62 | 7.37 |
| MnCe-A-200-NO₃ | 62.61 | 1.95 | 3.11 |
| MnCe-U-300-NO₃ | 87.28 | 0.61 | 0.70 |
| MnCe-A-300-NO₃ | 65.58 | 2.87 | 4.38 |

FeCe-GAC

| | | Dissolved | |
|---|---|---|---|
| | Coating Amount | Amount | Dissolution |
| | (mg/g) | (mg/g) | Rate (%) |
| Code | Fe + Ce | Fe + Ce | Fe + Ce |
| FeCe-U-200-Cl | 77.41 | 18.97 | 24.51 |
| FeCe-A-200-Cl | 146.17 | 0.68 | 0.47 |
| FeCe-U-300-Cl | 70.97 | 13.76 | 19.40 |
| FeCe-A-300-Cl | 127.99 | 0.33 | 0.26 |
| FeCe-U-200-NO₃ | 97.28 | 0.15 | 0.16 |
| FeCe-A-200-NO₃ | 60.55 | 1.34 | 2.21 |
| FeCe-U-200-NO₃ | 97.9 | 0.25 | 0.25 |
| FeCe-A-200-NO₃ | 51.38 | 2.93 | 5.71 |

FeMn-GAC

| | | Dissolved | |
|---|---|---|---|
| | Coating Amount | Amount | Dissolution |
| Code | (mg/g) | (mg/g) | Rate (%) |
| FeMn-U-200-Cl | 39.55 | 3.71 | 9.39 |
| FeMn-A-200-Cl | 111.29 | 3.60 | 3.24 |
| FeMn-U-300-Cl | 32.13 | 2.83 | 8.81 |
| FeMn-A-300-Cl | 90.5 | 3.50 | 3.87 |
| FeMn-U-200-NO₃ | 169.61 | 1.58 | 0.93 |
| FeMn-A-200-NO₃ | 74.49 | 1.66 | 2.22 |
| FeMn-U-300-NO₃ | 148.97 | 0.70 | 0.47 |
| FeMn-A-300-NO₃ | 76.1 | 2.52 | 3.29 |

Humic Acid Removal Test:

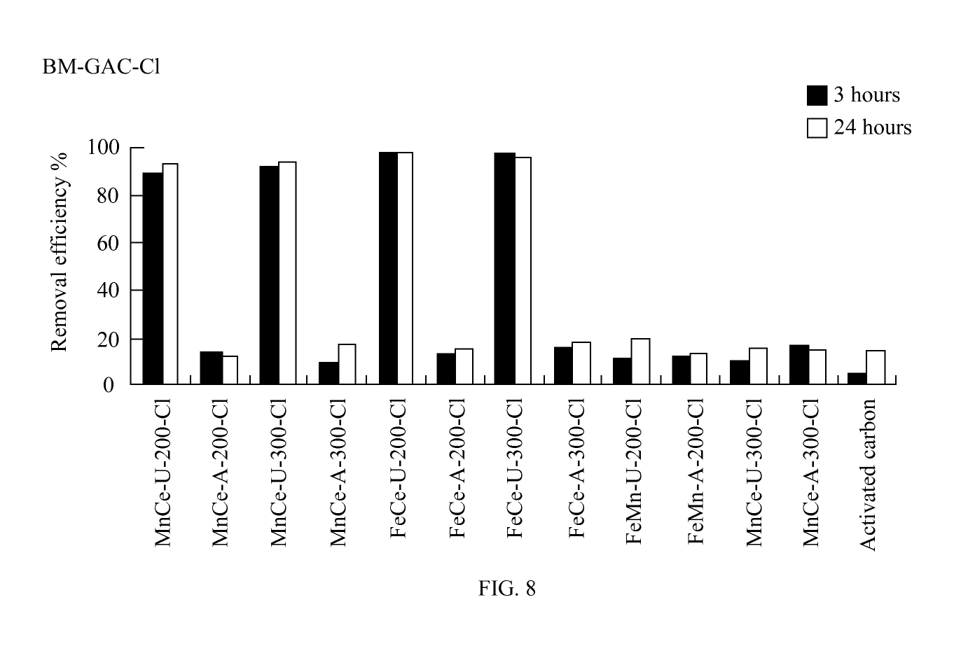

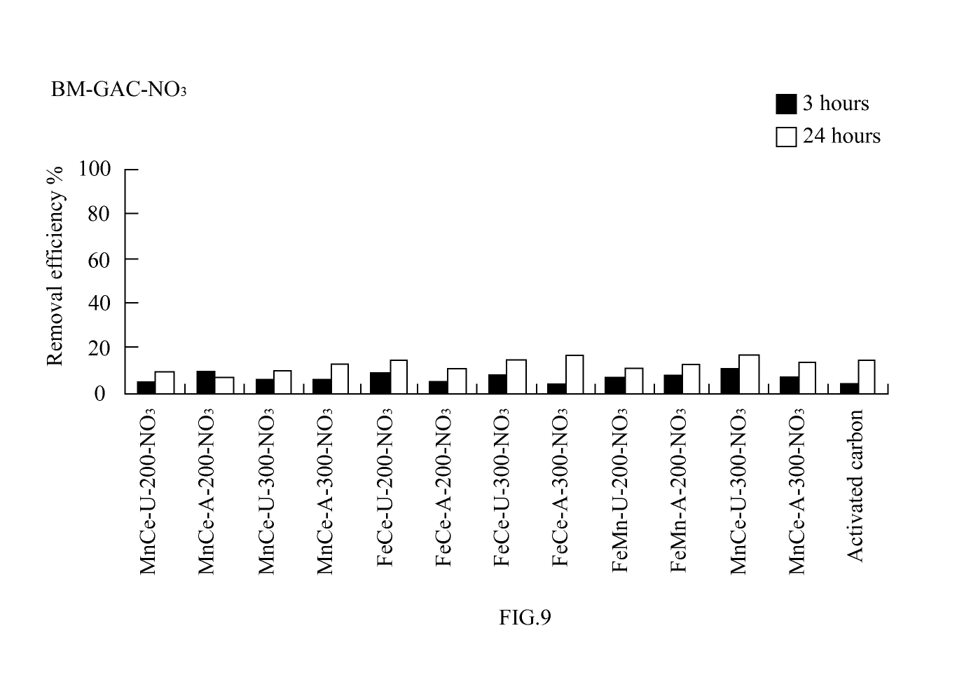

Experiments on the workability of different types of BM-GAC at pH 6, for example, for treating humic acid are conducted under following conditions: humic acid concentration of 100 mg/L, 0.01 N NaNO₃, 1 g/L of BM-GAC at pH 6, and mixing speed of 50-60 rpm are used, and the solution is sampled at 3 and 24 hours, separately, for analyzing the humic acid concentration thereof. Results from the experiments indicating the humic acid removal efficiency of three different types of BM-GAC, namely, MnCe-GAC, FeCe-GAC and FeMn-GAC are listed in FIGS. 8 and 9. As can be seen from FIGS. 8 and 9, MnCe-U-200-Cl and MnCe-U-300-Cl as well as FeCe-U-200-Cl and FeCe-U-300-Cl show the best humic acid removal efficiency compared to other types of BM-GAC, and the removal efficiency thereof is higher than 90%, which is 6 times higher than the humic acid removal efficiency of about 15% by the activated carbon. However, with respect to the influence of different metal salts on the humic acid removal efficiency of differently prepared BM-GAC, it is indicated in the experimental results that the types of BM-GAC prepared with metal chlorides show humic acid removal efficiency higher than that of the types of BM-GAC prepared with metal nitrates. For example, all types of BM-GAC prepared with metal nitrate show humic acid removal efficiency smaller than 18%. Further, all types of BM-GAC prepared with metal chlorides at pH<2.5 show higher humic acid removal efficiency compared to other types of BM-GAC. But, different calcite temperatures have no significant influence on the humic acid removal efficiency of the BM-GAC.

Influence of Oxidant, Such as Ozone, on the Humic Acid Removal Efficiency:

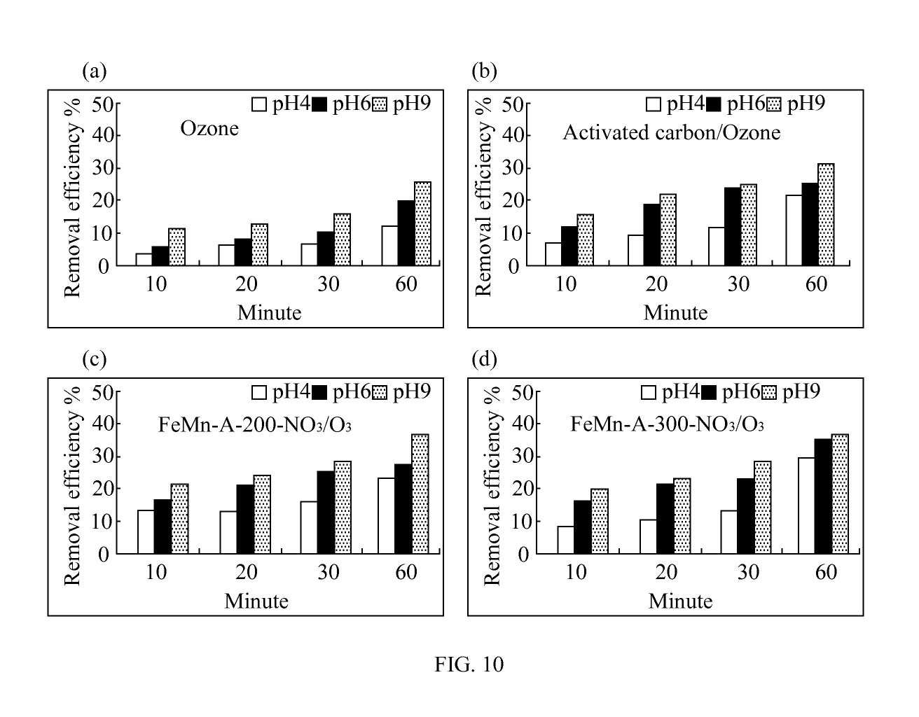

Experiments have also been conducted to determine the contribution of ozone on the humic acid removal with BM-GAC prepared at different metal salts, including chloride and nitrate. The experiments are conducted under the following conditions: two different humic acid concentrations of 100 and 250 mg/L, different types of BM-GAC with dosage of 2 g/L and at different pH values of 4, 6, and 9, and ozone generated at a voltage of 40V is supplied at a flow of 2 L/min. According to the results from these experiments, FeMn-A-200-NO₃/O₃ and FeMn-A-200-Cl/O₃ have humic acid removal efficiencies of 60 and 61%, respectively. These are no significant difference between these processes. In addition, BM-GAC at pH 9 shows the highest humic acid removal efficiency while BM-GAC at pH 4 show the lowest humic acid removal efficiency, as shown in FIG. 10. For example, FeMn-A-200-NO₃/O₃ at pH 9, 6, and 4 has humic acid removal efficiency of 39, 29 and 26%, respectively, at a reaction time of 60 minutes.

Influence of Oxidant, Such as Hydrogen Peroxide, on the Humic Acid Removal Efficiency:

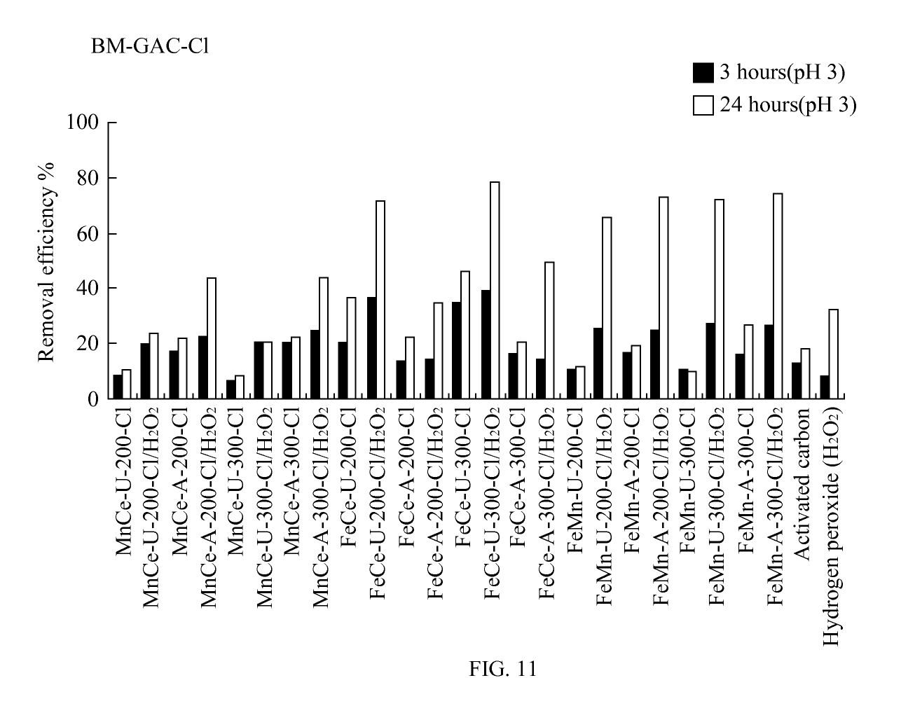

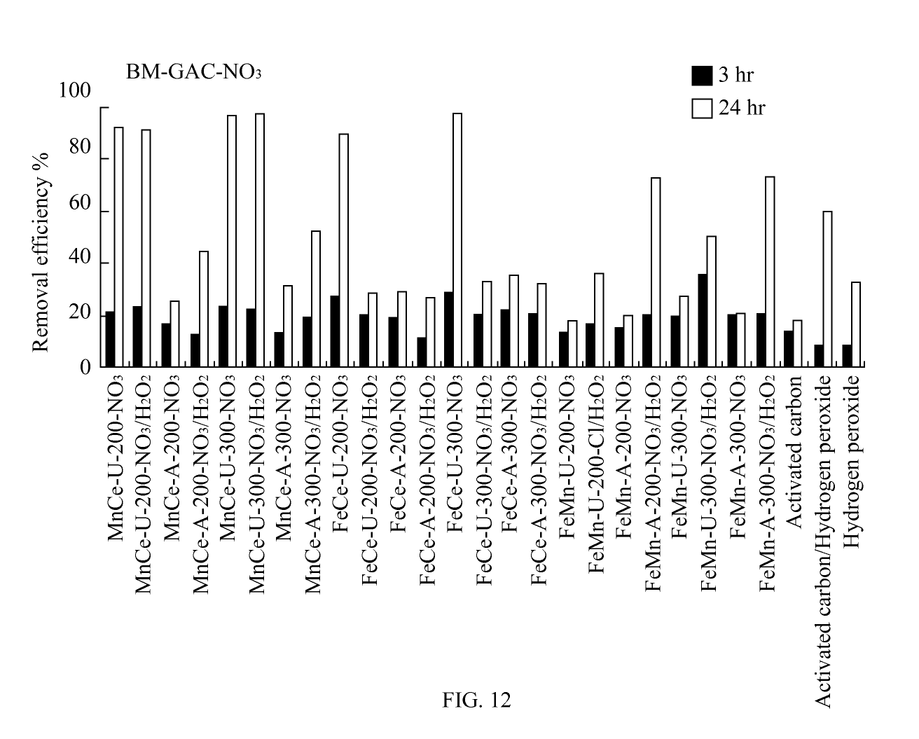

Experiments have also been conducted to determine contribution of hydrogen peroxide on the humic acid removal efficiency with BM-GACs. The experiments are conducted under the following conditions: humic acid concentration of 100 mg/L, 0.01 N NaNO₃, different types of BM-GAC at dosages of 0.5 and 1 g/L, different pH values of 3, 6, and 9, hydrogen peroxide dosage of 1 ml/L, and reaction times of 3 and 24 hours, respectively. As for BM-GAC prepared by metal chloride salts, experimental results indicated that humic acid removal is significantly improved by the addition of hydrogen peroxide at pH 3. For example, humic acid removal by MnCe-GAC/H₂O₂ is significantly better than that of MnCe-GAC alone. Similar results are true for FeCe-GAC and FeMn-GAC as show in FIGS. 11 and 12.

Copper Ion Adsorption Test:

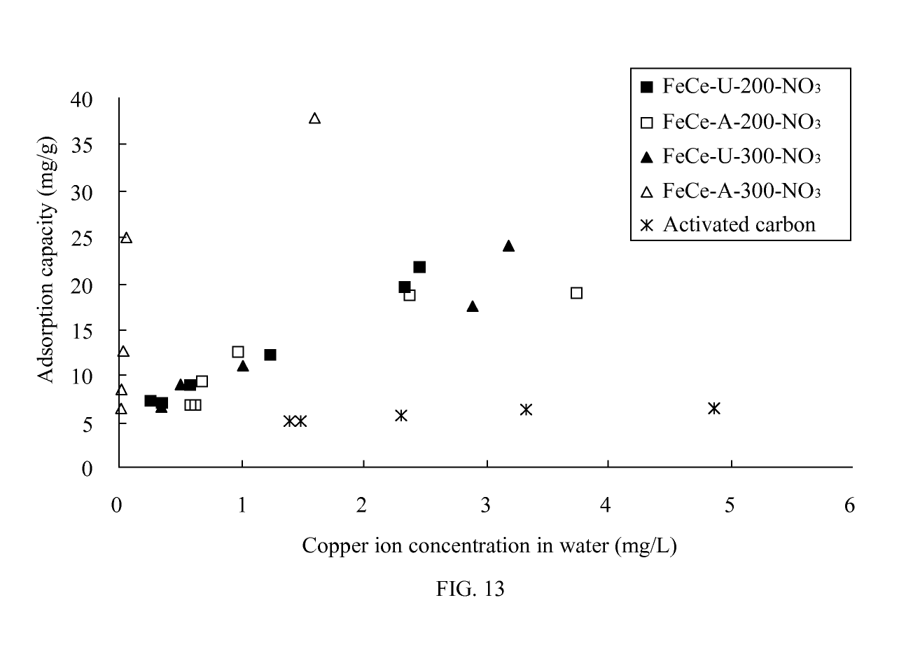

Experiments are conducted to determine the copper ion adsorption capacity of BM-GACs prepared according to the present invention. The experiments are conducted under the following conditions: initial copper ion concentration of 6 mg/L, pH 6, 0.01 N NaNO₃, and reaction time of 7 days are used. MnCe-GAC, FeCe-GAC and FeMn-GAC all show higher copper ion adsorption capacity than that of the pure activated carbon. In addition, copper ion adsorption capacity are in the following order FeCe-GAC>FeMn-GAC>MnCe-GAC. Among BM-GACs, FeCe-A-300-NO₃ has the best copper ion adsorption capacity (25 mg/g), which is about 4 times higher than that of the activated carbon, as shown in FIG. 13. In addition, a higher calcining temperature, such as 300° C., is helpful in increasing the copper ion adsorption capacity of BM-GAC.

The Use of BM-GAC in Treating Humic Acid and Copper Ion (Copper (II)) at the Same Time:

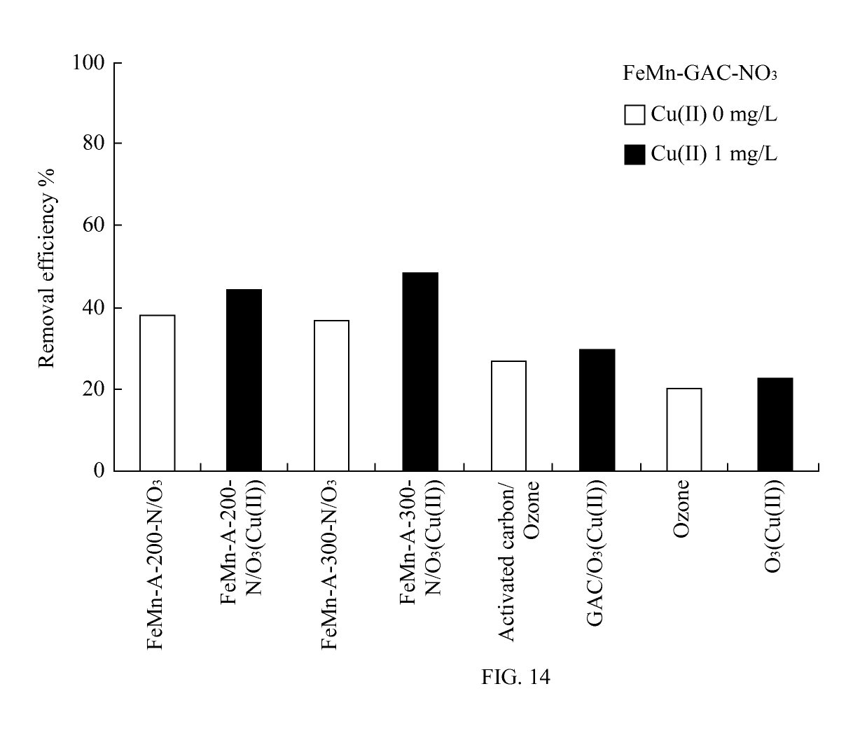

In leachate, in addition to humic acid, it might contain heavy metals. Therefore, experiments have also been conducted to find out the influence of copper ion in leachate on the humic acid removal efficiency for different types of BM-GAC prepared according to the present invention. The experiments are conducted under the following conditions: humic acid concentration is 250 mg/L, pH value is 6, ozone generated at a voltage of 40V is supplied at a flow of 2 L/min, and copper ion concentration is 1 mg/L. Results from the experiments are shown in FIG. 14. The existence of copper ion (copper (II)) in the humic acid-containing solution can enhance humic acid removal efficiency of BM-GAC-NO₃/O₃. Taking FeMn-A-200-NO₃/O₃ as an example, when the copper ion concentration is increased from 0 to 1 mg/L, the humic acid removal efficiency of FeMn-A-200-NO₃/O₃ is increased from 38% to 44%.

Test on Repeated Use of BM-GAC:

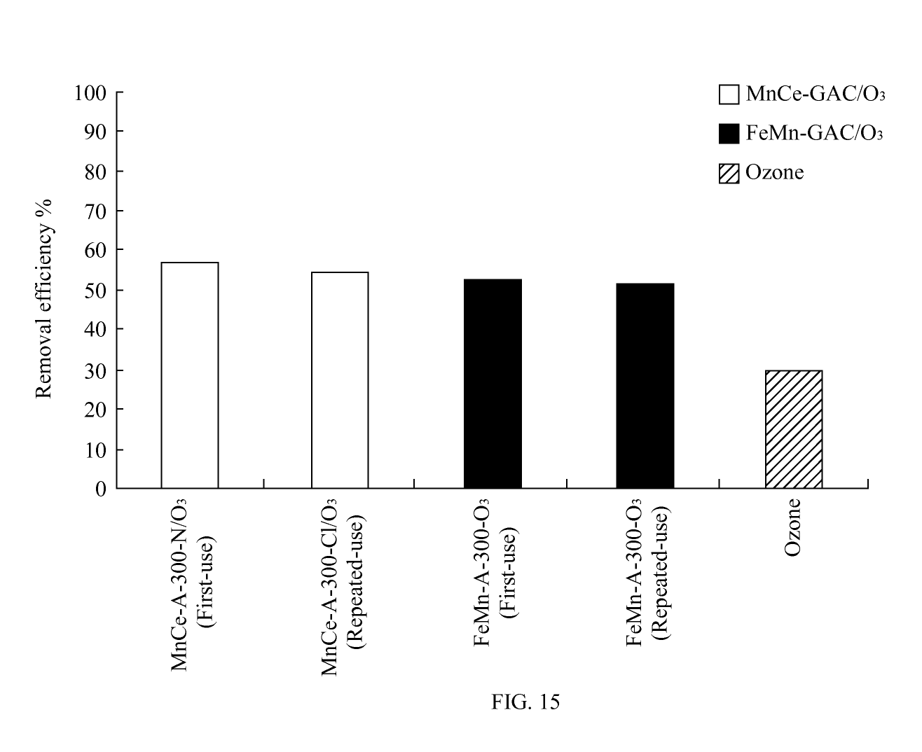

Experiments have also been conducted to find out the repeated usability of different types of BM-GAC prepared according to the present invention. The experiments are conducted under the following conditions: the humic acid concentration is 100 mg/L, the pH value is 6, and ozone generated at a voltage of 40V is supplied at a flow of 2 L/min Results from the experiments are shown in FIG. 15, and it is found the humic acid removal efficiency of the repeatedly used BM-GAC does not significantly decreased. For example, the humic acid removal efficiency of MnCe-A-300-NO₃ at first-use and second-use thereof are 56% and 55%, respectively.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A manufacturing method of a composite as adsorbent and catalyst, comprising the following steps:
adding activated carbon into an aqueous solution comprising a plurality of metal salts;
adjusting the aqueous solution to a predetermined pH value according to types of the plurality of metal salts;
drying the aqueous solution comprising the plurality of metal salts and the activated carbon, and slowly stirring the aqueous solution simultaneously during drying; and
calcining a product obtained after the aqueous solution is dried, such that metal oxides comprising a plurality of metals coated on a surface or filled in pores of the activated carbon.

2. The manufacturing method of the composite as adsorbent and catalyst as claimed in claim 1, wherein the calcining step is performed at a calcining temperature ranged between 50 and 600° C.

3. The manufacturing method of the composite as adsorbent and catalyst as claimed in claim 2, wherein the calcining temperature is further ranged between 100 and 350° C.

4. The manufacturing method of the composite as adsorbent and catalyst as claimed in claim 2, wherein the calcining step is performed in a nitrogen environment or an oxygen-free environment.

5. The manufacturing method of the composite as adsorbent and catalyst as claimed in claim 1, wherein the types of the plurality of metal salts comprise chlorides, nitrates, or sulfates.

6. The manufacturing method of the composite as adsorbent and catalyst as claimed in claim 1, wherein the plurality of metals comprise a transition metal or an inner transition metal.

7. The manufacturing method of the composite as adsorbent and catalyst as claimed in claim 6, wherein the transition metal comprises iron (Fe) or manganese (Mn), and the inner transition metal comprises cerium (Ce).

8. The manufacturing method of the composite as adsorbent and catalyst as claimed in claim 1, wherein the plurality of metal salts are ferric chloride and manganese chloride, ferric chloride and cerium chloride, or cerium chloride and manganese chloride; and the predetermined pH value corresponding to the ferric chloride and manganese chloride, the ferric chloride and cerium chloride, or the cerium chloride and manganese chloride ranges between 9 and 12.

9. The manufacturing method of the composite as adsorbent and catalyst as claimed in claim 1, wherein the plurality of metal salts are ferric nitrate and cerium nitrate, or ferric nitrate and manganese nitrate; and the predetermined pH value corresponding to the ferric nitrate and cerium nitrate, or the ferric nitrate and manganese nitrate is smaller than 5.

10. The manufacturing method of the composite as adsorbent and catalyst as claimed in claim 1, wherein the metal oxides coated on the surface of the activated carbon form a nanostructure coating.

11. A composite as adsorbent and catalyst, comprising:
activated carbon; and
metal oxides coated on a surface of the activated carbon or filling pores of the activated carbon, and being oxides comprising a plurality of metals.

12. The composite as adsorbent and catalyst as claimed in claim 11, wherein the plurality of metals comprise a transition metal or an inner transition metal.

13. The composite as adsorbent and catalyst as claimed in claim 12, wherein the transition metal comprises iron (Fe) or manganese (Mn), and the inner transition metal comprises cerium (Ce).

14. The composite as adsorbent and catalyst as claimed in claim 11, wherein the metal oxides coated on the surface of the activated carbon form a nanostructure coating.

15. A wastewater treatment method, comprising the following step:
adding the composite as adsorbent and catalyst obtained using the manufacturing method as claimed in claim 1 into wastewater comprising a contaminant, such that the contaminant is adsorbed onto the composite.

16. The wastewater treatment method as claimed in claim 15, wherein the contaminant comprises a heavy metal, and the heavy metal comprises a copper ion, a nickel ion, a lead ion, a cadmium ion or an arsenic ion.

17. The wastewater treatment method as claimed in claim 15, wherein the contaminant comprises an organic substance, and the organic substance comprises humus, a fatty acid, a sulfonic acid substance or a dye.

18. The wastewater treatment method as claimed in claim 17, further comprising a step of adding an oxidant into the wastewater, such that the oxidant is catalyzed by the composite to generate free radicals oxidizing the contaminant adsorbed onto the composite.

19. The wastewater treatment method as claimed in claim 15, wherein the oxidant comprises ozone (O₃) or/and hydrogen peroxide (H₂O₂).

20. The wastewater treatment method as claimed in claim 19, wherein a pH value of the wastewater comprising the ozone ranges between 8 and 14.

21. The wastewater treatment method as claimed in claim 19, wherein a pH value of the wastewater comprising the hydrogen peroxide ranges between 1 and 5.

22. The wastewater treatment method as claimed in claim 15, further comprising a step of irradiating the wastewater comprising the composite, the contaminant and the oxidant with ultraviolet irradiation, such that the composite or the oxidant generates the free radicals, and the generated free radicals oxidizes the contaminant adsorbed onto the composite.
